(19) United States
(12) Patent Application Publication
(10) Pub. No.: US 2012/0303353 A1
(43) Pub. Date: Nov. 29, 2012

(54) APPARATUS, METHOD AND SYSTEM FOR LOCATING AND MONITORING THE MOVEMENT OF AN OBJECT

(76) Inventor: Farid Souluer, Chester Springs, PA (US)

(21) Appl. No.: 13/426,880

(22) Filed: Mar. 22, 2012

Related U.S. Application Data
(60) Provisional application No. 61/465,673, filed on Mar. 22, 2011.

(51) Int. Cl. H04W 24/00; G06F 17/28

(52) U.S. Cl. 704/2; 455/456.1; 455/457

(57) ABSTRACT

A method, system and apparatus for locating and monitoring the movement of an object, including a transmitting component and a decoding component, where the decoding component is configured to communicate with the transmitting component through a voice channel of a wireless telephone network, the transmitting component including a global positioning system (GPS) chip, and where the GPS chip is linked with the transmitting component circuitry to transmit location information to said decoding component through a voice channel. Embodiments include a management engine for managing subscriptions to the location information, map software for displaying with the location information a location of the transmitting component and its movement, and a speech translation engine for providing audible voice speech identifying the location information corresponding to the transmitter location or path of travel.

### BACKGROUND OF THE INVENTION

1. Field of the Invention

The present invention relates to communication and tracking devices and more particularly to systems, methods and devices for locating an object and monitoring the location of an object as the object continues to move.

2. Brief Description of the Related Art

There are methods and devices that have been employed to locate individuals or objects. In some cases, a global positioning system (GPS) is used and relies on signals from satellites. For example, an object may carry a GPS receiver that is designed to communicate with satellites that the receiver encounters at the receiver location. A GPS receiver uses a signal from the satellite, and from having the signals of at least three satellites is able to calculate a specific location on the Earth.

Another type of global positioning system (GPS) utilizes short messaging service (SMS) to send a location to a wireless company and from there to the host. In the SMS type of system, a location protocol is utilized by the wireless telephone and the location code is sent through the text message band. Since text messages may be backed up, and in many cases are saved on the wireless device before they are sent, or are backed up on the wireless network (e.g., cellular network), the location information is not reliable for tracking the wireless device in real-time. The delay can provide undesirable consequences, especially for law enforcement, security and rescue personnel, who, using SMS systems for location information, may receive no data, a drop off of data, or stale data.

A need exists for a device, system and method that provides an economical way to monitor the location of a moving object as the object is moving in real time.

### SUMMARY OF THE INVENTION

An economical and reliable device, system and method are provided for monitoring the location of an object, and, more particularly, for monitoring the movement of an object.

According to one embodiment, a mobile unit is provided to be carried by the person or object whose position is desired to be located.

It is an object of the present invention to provide a device, system and method that receives and transmits location data in a manner with minimal or no delay.

It is an object of the present invention to provide a device, system and method that receives and transmits location data through a voice band of a wireless telephone network.

It is an object of the present invention to provide a device, system and method that receives and transmits location data and is operable in locations where cells phones are operable and/or where satellite telephones may be used.

It is an object of the present invention to provide a device, system and method that receives and transmits location data that uses available cellular telephone networks.

It is another object of the present invention to accomplish the above objects where the communications comprise dual tone modulation frequencies (DTMF's).

It is another object of the present invention to accomplish the above objects where the communications comprise encrypted data.

It is a further object of the invention to provide a receiver that may be linked through a wireless network to a server so that the receiver may be configured to initiate and/or receive telecommunications from the server to another device, such as, for example another telephone. It is a further object to accomplish the above object where the server is configured to initiate and receive voice over IP (VOIP) communications.

It is a further object of the invention to provide a receiver that communicates with a decoder, and wherein the decoder is linked with a computer and wherein said decoder may communicate using said computer.

It is another object of the invention to accomplish the above objects where software containing instructions is provided on a receiver, a decoder and a computer to implement communications and manage location data between the receiver and decoder and provide the location data in the form of raw data, processed data, a display, audible speech or any combination of these.

### BRIEF DESCRIPTION OF THE DRAWINGS

FIG. 1 is an illustration of a first embodiment of a receiver or mobile unit according to the present invention.

FIG. 2 is an illustration of a first embodiment of a decoder according to the present invention.

FIG. 3 is a schematic illustration of a preferred arrangement of a method and system for monitoring location and movement of an object implemented with the mobile unit and decoder of FIGS. 1 and 2, respectively.

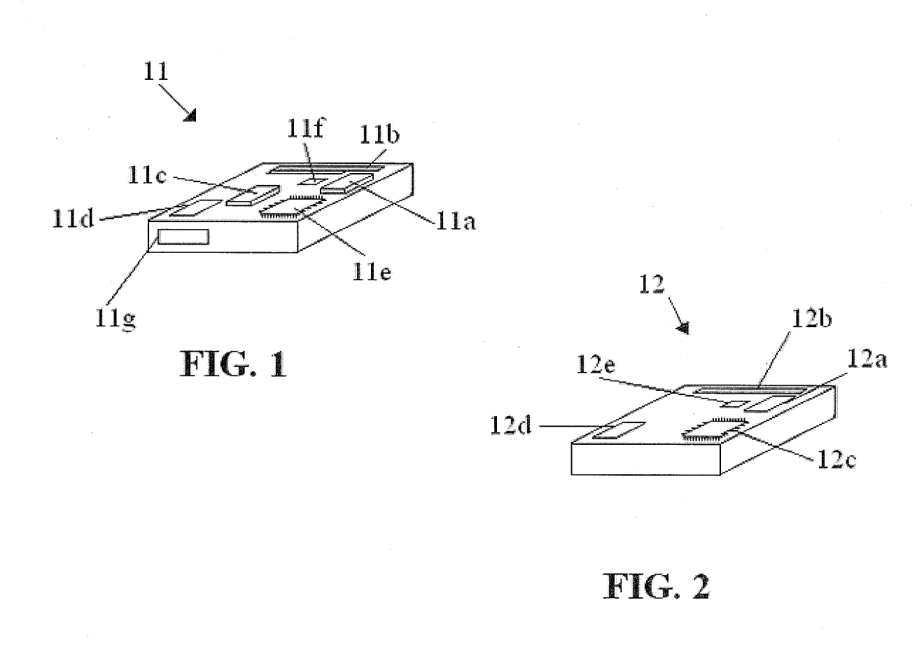

### DETAILED DESCRIPTION OF THE PREFERRED EMBODIMENTS

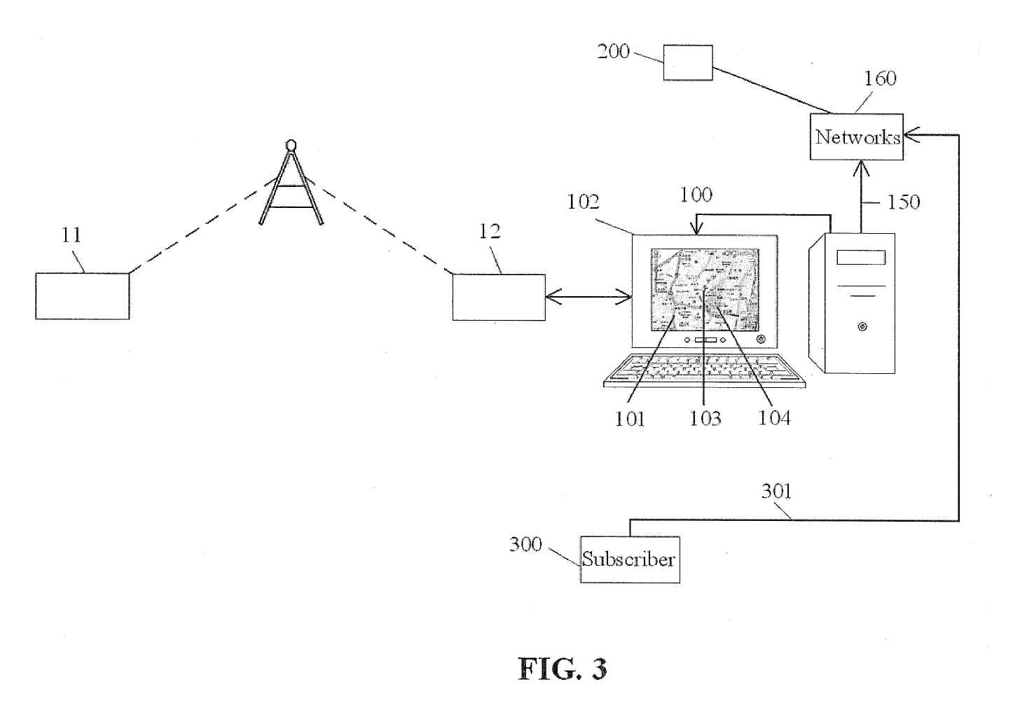

A method, system and device are provided for monitoring the location of an object and tracking the object as the object moves. The invention preferably comprises components for communicating the location information, including a transmitting component or mobile unit 11 and a decoding component, such as, the decoder 12. A computing component, such as, for example, a computer 100 (FIG. 3) that is linked with the decoder 12 is provided or used to process the location information. According to this preferred embodiment, a computer may be one already used for other tasks, and with which the decoder 12 and software implementing the communication management and data handling may be used. According to a preferred embodiment, the location information received by the decoder 12 from the mobile unit 11 is processed to determine one or more location coordinates (such as longitude and latitude values) and display those coordinates on a display 102 (FIG. 3), such as, for example, a computer screen, television, or other monitor. The display 102 may include an image of a map 101 and may list location names and landmarks thereon (e.g., cities, streets, monuments, businesses). A representation graphic image 103 preferably is displayed on the map 101 to provide the location of the mobile unit 11. The map display may be any of those commercially available maps, including Streets and Trips (Microsoft), MapPoint (Microsoft), MapSource (Garmin), Google Maps, Google Earth, or other map software, and the computer 100 may be used to operate the map software. The information received by the decoder 12 may be processed and provided as a data array of location coordinates, such as, for example, GPS values of longitude and latitude representing the position of the mobile unit 11 at a particular time, which preferably, is sufficiently close to or, preferably, at the time that the mobile unit 11 transmits the signal to the decoder 12.

According to a preferred embodiment, the mobile unit 11 is configured with a power supply that may be internal or external, or it may have options for being powered by both. A battery 11g (internal or external) may be supplied to power the mobile unit 11, and, in addition, the mobile unit 11 may be configured to be powered by other available power sources. For example, where the mobile unit 11 is carried with or is associated with a vehicle, the power supplied by a vehicle's power generating components, e.g., a vehicle's battery, may be used to supply power to the mobile unit 11. The mobile unit 11 preferably includes signal generating circuitry and an antenna 11b for transmitting signals from the mobile unit 11. The mobile unit 11 preferably has a microprocessor and further preferably includes circuitry of a cellular telephone to permit the mobile unit 11 to receive and transmit signals, and preferably to generate signals that contain location information. The mobile unit 11 preferably includes a transmitter 11a, an antenna 11b and a global positioning system (GPS) module 11c that contains a GPS chip. The GPS module 11c is linked with the transmitter 11a to transmit location information. Preferably, circuitry is provided, including a microprocessor 11e, and embedded logic in the form of software stored on a chip or card is provided to control the operations of the mobile unit 11. The software preferably includes instructions to implement recognition of an incoming request, such as, for example, an authentication ping, from the decoder 12, and to implement a routine that obtains and provides a response to the decoder 12 which comprises location information obtained from the GPS module 11c. The recognition may be a handshake, e.g., a programmed electronic agreement or arrangement as to how the mobile unit 11 and decoder 12 will send or exchange information.

The location information from the mobile unit 11 is transmitted to the decoder 12. The decoder 12 may be, and preferably is, provided at a location remote from the location of the mobile unit 11. Preferably, the mobile unit 11 and decoder 12 are configured to communicate with each other, and more preferably, the mobile unit 11 and decoder 12 are configured to communicate on a voice band or frequency through the voice bands of a wireless network, including, for example, on a wireless cellular communication network. The decoder 12 preferably is configured with software that may be provided on a chip. The software preferably implements a routine that includes instructing the decoder 12 to ping the mobile unit 11. The mobile unit 11 preferably includes a GPS module 11c. When the mobile unit 11 is pinged by the decoder 12, the mobile unit 11 location will be ascertained, as the location information obtained by the GPS module 11c will be processed by the mobile unit microprocessor 11e and transmitted to the decoder 12. According to preferred embodiments, the decoder 12 may wake up the mobile unit 11 by contacting the mobile unit 11, e.g., by calling the mobile unit 11 or pinging it. The mobile unit 11 may be configured to respond to a particular request (e.g., a call, code, ping or other command) received from the decoder 12. Although the location of a cell tower may provide a rough indication of the location of a cellular telephone that responds in the vicinity of the tower, the GPS module 11c of the mobile unit 11 provides a precise location, which preferably may be within a few to several feet of the actual location of the mobile unit 11.

According to preferred embodiments, the system, method and devices of the invention are designed to function in those locations where a cell phone will work. The system, method and devices are designed to utilize existing (or new) cellular network infrastructure, and more preferably, to transmit communications between the mobile unit 11 and decoder 12 that are voice channel or voice band communications. Preferably, the mobile unit 11 is provided with a keyboard or keyboard buffer that enables each corresponding key to be associated with a dual tone modulation frequency (DTMF). Preferably, the present mobile unit 11 utilizes the keyboard or keyboard buffer to generate DTMF. In embodiments where the mobile unit 11 is provided without a keyboard, the DTMF is utilized through software, firmware, hardware and/or buffer that may be configured on the mobile unit to implement DTMF signals.

According to a preferred embodiment, a handshake is established between the mobile unit 11 and decoder 12 to authenticate the communication. For example, the decoder 12 may initiate a communication to the mobile unit 11, and the mobile unit 11 may return an authentication string that preferably comprises DTMF signals on the voice band. Once authenticated, then the mobile unit 11 and decoder 12 may exchange further communications with each other, including location data. The system may be configured in this manner to prevent tampering where a mobile unit 11 is not authenticated, and therefore may not be the component that the decoder 12 considers it to be.

According to an alternate or optional embodiment, the present invention also provides a mobile unit 11 that may be configured with a receiver or handset which may be used to make voice communications over the cellular network through the mobile unit transmitter 11a and other components of the mobile unit 11, which according to this embodiment are configured to process and receive voice communications. According to one embodiment, the mobile unit 11 is configured so that a user may operate a wired or wireless (e.g., Bluetooth) handset that may be used to place telephone calls to another telephone or device through the mobile unit 11. According to an alternate embodiment, the mobile unit 11 is configured to communicate through the decoder 12, and signals from the mobile unit 11 are transmitted to the decoder 12. The decoder 12, according to one embodiment, is connected to a computer, and provides the mobile unit 11 with the functionality of the computer, such as, for example, placing and engaging in communications made through the computer, including voice communications, such as, for example, VOIP telephone communications.

According to a preferred embodiment, the mobile unit 11 has a digital signal processor (DSP) 11d that is configured to perform signal-manipulation calculations at high speed, including, for example, numbers of complex arithmetic calculations as quickly as possible. The mobile unit 11 preferably also includes a microprocessor 11e that is configured to handle the processing of instructions in the manner that a cell phone microprocessor handles cell phone chores, including, for example, housekeeping chores for the keyboard and display. According to an alternate embodiment, the mobile unit 11 may be provided without a keyboard or display, if desired, and the microprocessor 11e may be configured to process the location information of the GPS module 11c and implement the transmission of the location data to the decoder 12. The microprocessor 11e therefore coordinates the functions on the board with the other components of the circuitry (e.g., the transmitter, DSP and GPS chip) and handles the command and control signaling, including the communications with the decoder 12. The microprocessor 11e preferably is connected to receive information from the GPS module 11c or receiver. The GPS module 11c preferably is connected in a circuit that includes an antenna 11b, and may include a separate GPS antenna, or may utilize the antenna 11b of the mobile unit 11 that the mobile unit 11 uses to communicate signals between the decoder 12.

According to preferred embodiments, the mobile unit 11 preferably has an operating system loaded onto one or more memory chips, such as for example, ROM and/or flash memory chips. The operating system may be any of those operating systems that are used to manage and run cellular telephones, that can be configured to manage the operations of the mobile unit 11 and the signal transmissions between the mobile unit 11 and decoder 12, as well as the GPS module 11c and GPS data. The microprocessor 11e and DSP 11d, according to some embodiments, may be combined.

The mobile unit 11 preferably has signal transmission and receiving means for transmitting and receiving signals. For example, the signal transmitting and receiving means may comprise a radio frequency (RF) circuit that enables the mobile unit 11 to communicate through a number of channels, which preferably are on the voice frequency band. The mobile unit 11 preferably includes an RF amplifier 11f and an antenna (such as the antenna 11b). The RF amplifier 11f preferably, with the transmitter 11a, provides signals to the antenna 11b.

According to one embodiment, the decoder 12 preferably may be constructed in a manner similar to the mobile unit 11, but without the GPS chip. According to an exemplary embodiment, the decoder 12 is illustrated in FIG. 2 having a transmitter 12a, an antenna 12b, a microprocessor 12c, a digital signal processor (DSP) 12d, and an RF amplifier 12e. Preferably one or more storage components, such as memory chips (not shown), may be provided on the mobile unit 11 and on the decoder 12. Software, including an operating system, engines or other instructions used to manipulate the microprocessors 11e, 12c of the mobile unit 11 and decoder 12 and manage the transmissions, respectively, may be provided on a memory. The memory may comprise memory means, such as, for example, flash memory, embedded logic chips, a hard drive or other suitable storage medium where the software, instructions, location data and other information may be stored.

According to one embodiment, the decoder 12 preferably, like the mobile unit 11, is configured to operate on a wireless telephone network, and communicates on the voice channel. The mobile unit 11 and decoder 12 may use the same or different wireless network carriers. According to alternate embodiments, one of the mobile unit 11 or decoder 12 may communicate using a satellite based network and the other or both a cellular network. According to alternate embodiments, the mobile unit 11 is configured to communicate through both a satellite network and through a cellular network. According to an alternate embodiment, the decoder 12 may include plain old telephone service (POTS) communication capability. The decoder 12 may be configured to communicate with the mobile unit 11 through a land line. In this embodiment, the decoder 12 preferably would not require wireless components, such as for example, a transmitter, antenna or RF amplifier, but it optionally could include components that pet nit wired and wireless communications (e.g., in the event that the wired or land communications were disabled or temporarily unavailable, e.g., due to a service interruption).

The mobile unit 11 has been described according to a preferred exemplary embodiment and may be constructed with alternate configurations that provide the capability for the mobile unit 11 to transmit and receive signals between the decoder 12 through the voice channel or band of communications through a wireless network, preferably, a cellular telephone network. Preferably, the mobile unit 11 includes an operating system that is embedded on a chip or memory and may be programmed in conjunction with the circuitry and other components of the mobile unit 11 to handle the signal processing and transmission.

According to alternate embodiments, the mobile unit 11 may include a Subscriber Identity Module (SIM) card that may hold personal identity information, the telephone number or other identification number of or assigned to the mobile unit 11, as well as other data. The decoder 12 also may include a SIM card.

According to embodiments where the mobile unit 11 is configured with a handset or is configured for use with an optional handset, the mobile unit 11 and/or handset may include analog to digital (A/D) converter chips and digital to analog (D/A) converter chips that translate the outgoing audio signal (e.g., a voice call transmission made) from analog to digital and the incoming signal from digital back to analog (e.g., for a voice call transmission received or for data).

According to one embodiment, the mobile unit 11 may be configured to operate on a frequency of 800 to 1900 MHz, or another frequency used for the voice band of cellular telephone communications. For example, the frequencies may be 824 MHz to 894 MHz for analog cell phones using the AMPS standard, or may be in the 800 MHz bands, 1800 MHz or 1900 MHz in the case of other standards, such as, for example, TDMA, CDMA, GSM standards. According to some embodiments, it is common that the transmit voice channels and receive voice channels are separated by 45 MHz for some communications, and by narrower bands, such as 30 MHz for others (e.g., TDMA). The communications between the mobile unit 11 and the decoder 12 may be made through the forward voice (FOVC) and reverse voice (REVC) channels of a cellular system.

The mobile unit 11, decoder 12 and the method and system of the present invention preferably utilize existing wireless telephone networks, and preferably, the mobile unit 11 and decoder 12 communicate through the networks that support cellular voice telephone communications. In this manner, as the mobile unit 11 travels along with the object whose movement the mobile unit 11 is assigned to track, the mobile unit 11 preferably maintains communication with the decoder 12 by the switching of the cell, or hand-off, where a new voice channel may be used by the mobile unit 11 (although, as in a cellular voice call, there may be a brief delay, which for purposes of the tracking and monitoring is substantially instantaneous). The mobile unit 11 and decoder 12 preferably are configured to communicate and pass information to each other through the voice channel of the cellular network on which they are communicating.

According to a preferred embodiment, the tracking and monitoring operations are implemented using the mobile unit 11 and decoder 12. The mobile unit 11 and decoder 12 initiate a recognition routine to recognize each other. The decoder 12 may send a signal to the mobile unit 11. The mobile unit 11 may be configured to remain accessible so that when it is addressed by the decoder 12 (e.g., by a telephone number associated with the mobile unit), the mobile unit 11 issues a response that the decoder 12 authenticates, or alternately, or in addition, the mobile unit 11 may receive a signal from the decoder 12 and may then authenticate the signal. The authentication or handshake that may be implemented may range from a simple recognition of a telephone number to an encrypted signal or code string that the mobile unit 11, the decoder 12, or both are configured to process and decrypt to verify the communication. According to preferred embodiments, the communications between the mobile unit 11 and decoder 12 may be encrypted to provide a level of security for the communications.

The decoder 12 preferably associates the mobile unit 11 with a unique identification for that unit 11, and the communications between the decoder 12 and the mobile unit 11 are associated with that mobile unit unique identification (serial number, SIM card information, or other unique identifier). The mobile unit 11 is powered and the GPS circuitry receives and provides GPS signal information that the mobile unit 11 processes and transmits to the decoder 12 through the voice channel on which the mobile unit 11 and decoder 12 are communicating. The decoder 12 is configured to continuously receive transmissions from the mobile unit 11 that correspond with and contain the GPS location information identifying the location of the mobile unit 11. The connection may continue until the decoder 12 is switched off. According to a preferred embodiment, the decoder 12 may be set to monitor the mobile unit 11 at all times, certain times, or when certain conditions occur. The decoder 12 may be configured to disconnect the communication with the mobile unit 11, such as, for example, where an object is returned to a desired location and has been secured. The GPS information that the decoder 12 receives from the mobile unit 11 preferably comprises longitude and latitude coordinates.

According to a preferred embodiment, as schematically illustrated in FIG. 3, the decoder 12 is linked with a computer 100 to provide the location data, in particular, the GPS longitude and latitude coordinates, to the computer 100 for processing, manipulation and storage of the data. The computer 100 preferably is configured with map software that displays a map 101 of the location or locations of interest (e.g., such as, for example, in the case of a motorized vehicle, North America), or may contain maps of areas beyond the anticipated travel of the object in the event that the object strays from its anticipated path or route. One example of map software is Google Maps. The computer 100 preferably includes a processor and a storage component, such as, for example, a hard drive. The computer 100 preferably is configured with software that is designed to read the location data provided by the decoder 12, which preferably, is location data for a particular associated mobile unit 11 (e.g., one corresponding to the mobile unit 11 unique identifier), and to provide instructions for processing the data to display the location of the mobile unit 11 on the map 101 of the display 102. According to a preferred embodiment, the computer 100 is configured with software that implements an overlay of an image 103 representing the mobile unit 11, or object that it is assigned to track, corresponding to the location coordinates of the mobile unit 11 and the relative position on the map display. In addition, the overlay may provide tracking indicia, such as, for example, a line or other shading to indicate a path of travel 104, which may be translucent to display the other map information (e.g., street names, landmarks and the like) over which it is displayed. The display may be made on a monitor, LCD screen, mobile device, PDA or other screen that may be viewed. Preferably, as illustrated in FIG. 3, the software is configured to update the location data and update the location of the mobile unit 11 on the display. Preferably, the display 102 shows a map with landmarks, cities, streets and/or other desired information, and shows the location and path of travel of the mobile unit based on the information transmitted to the decoder 12 through the voice channel of the cellular telephone network. For example, if the mobile unit 11 is moving, then the display 102 may be set to show movement based on the change of position of an icon or character (e.g., the image 103) presented for display on the map 101 that represents the location of the mobile unit 11.

The mobile unit 11 may be configured to operate on a cell phone network and with a cell phone plan. A cell phone service provider or carrier may be used or subscribed to so that the mobile unit 11 may make and receive communications on the carrier or provider's network. The communications may comprise the location information communication on the voice channel between the mobile unit 11 and the decoder 12. The decoder 12, as with the mobile unit 11, according to some embodiments, preferably, also may make and receive communications on a carrier or provider's network, and may subscribe to a cellular telephone service (which may be through a carrier different than that of the carrier or provider that provides cellular service for the mobile unit 11). Service providers may be selected and used based on coverage so that there is coverage provided in the locations anticipated that the mobile unit 11 will need to travel, and, in some cases also where the decoder 12 will be located.

According to a preferred embodiment, an existing cellular plan may be used for the mobile unit 11. According to preferred embodiments, the mobile unit 11 includes a handset that has an input device such as, for example, a keyboard, number pad, touch screen or other mechanism that the user may employ to input information, such as, for example, a telephone number, thereby permitting the user to make voice calls through the circuitry of the mobile unit 11. The input device may be wired to the mobile unit 11, or connected wirelessly with the mobile unit 11, such as, for example, with a Bluetooth connection.

According to an alternate embodiment, the decoder 12 is configured to communicate with a computer 100, and software is provided that manages the inputs received from the decoded component 12 and corresponds the inputs to operations handled by the computer 100. One preferred example is where the decoder 12 receives an input from the mobile unit 11 that is a call that the user of the mobile unit 11 desires to place, which, in this example, may be done through the computer 100, such as, for example, using VOIP connection 150 with a network 160 to establish a connection with another telephone device, such as, for example, another telephone 200. According to this embodiment, for example, the computer 100 may make internet calls and establish internet communications on behalf of the mobile unit 11. This allows the system to permit the mobile unit 11 to be used to provide relatively inexpensive communications, and no cost communications (except for the cost of the wireless communication between the mobile unit 11 and decoder 12, which may be a set cost or fixed monthly fee). According to embodiments, the mobile unit 11, through its connection with the decoder 12, may have available to it the full power of the computer 100 that the decoder 12 is linked with.

Although the present devices, methods and systems are discussed in connection with a cellular telephone service for handling communications between the mobile unit 11 and decoder 12, alternate communication services may be used. For example, satellite based telephone technology may be provided for the mobile unit 11, and the mobile unit 11 may communicate with the decoder 12 through the satellite communication system. As discussed with the embodiments utilizing the cellular telephone network, the decoder 12 may be linked with the computer 100, and the operations and functions of the computer, such as, for example, making calls or communications from the computer 100 as directed from the mobile unit 11, may be done.

According to an alternate embodiment, the mobile unit 11 and decoder 12 are provided to communicate and/or display information about the movement or location of an object. For example, the mobile unit 11 may be carried by or associated with an object whose location is of interest and is desired to be tracked. According to one example, the decoder 12 receives the location information from the mobile unit 11 and makes that information available to others. The others may be law enforcement, a company that owns the vehicles or objects that are being tracked, or another person or entity interested in tracking the vehicle or object. For example, an authorized individual or computer, such as, for example, a subscriber to a service, may track the location of an object by having an authorization code or other data or key that allows the subscriber to view the location information received by the decoder 12, and, which may include data received from the decoder 12 that is processed in conjunction with map software to provide a location. Subscribers may track the location of a device and the movement of a device (which may be a vehicle, an important person or other mobile structure). According to one example, the system may be configured so that individuals may utilize the system to ascertain the location and position of a bus on a bus route. According to this example, the individual may access the location information to determine where the bus currently is in its route so that the individual may determine how much time the bus will take to arrive at a particular stop or station (e.g., where the individual will board the bus). The individual also may check the location of the bus to determine whether the bus has already passed a desired location (e.g., where the individual learns that he or she missed the bus). The location information may be made available to an individual in number of ways, including audible voice via a telephone, a wall display, a smart phone, or other communication device that can obtain the information processed by the decoder 12.

According to embodiments of the invention, the subscription service provided to obtain location information may be free, may require user supplied information, or may be fee based, and preferably may be managed by a management engine that regulates access to the location information by providing subscribers with passwords, logons or other access keys. The management engine may include software that is programmed to create accounts for users and provide authorizations for a user based on the user subscription (which may be simply the user providing basic information, or which may be fee based where the user pays for the use of the service). According to one embodiment, a company may pay the management service to host the management engine so that users may access location information that the company (e.g., a transit service) desires be shared and accessible to the users.

According to alternate embodiments, a speech translation engine is provided and is used in conjunction with the information received by the decoder 12 to change text, such as, for example, location coordinates, or a location place associated with the location coordinates, to voice speech (e.g., spoken words). The spoken words, for example, may be useful where a person subscribes to a transit locating service, and dials a telephone number to hear location information about a particular bus route, and is told (through spoken voice words) the location of the bus (“at 3:45 p.m. bus 25 on the Frankford route is at 4^{th} and Main”). The subscriber 300 may dial a telephone number that connects with the system or network 160 to provide the location information received from the decoder 12. This is illustrated schematically in FIG. 3, where an optional subscriber 300 is shown linked with the network 160 and computer 100. For example, the speech translation engine may be configured as software that may be managed or operated with the computer 100. The speech translation engine is provided to ascertain the location information from the decoder 12 (which may be done through the computer 100 linked with the decoder 12) and the associated map software, so that particular locations may be spoken. A database of locations may be populated for each mobile unit 11, for example, for each bus on a transit route, and the location information called up (preferably in real or substantially near real time) based on the subscriber request. The management engine may be configured to supply the information to the speech translation engine, and landmarks, numerical street addresses, and the like may be included so that the spoken or audible location may include the spoken names of those desired landmarks and addresses or combinations of these and other indicators of location.

According to one preferred embodiment, the system is configured to monitor the movement of school buses and is provided with a mobile unit 11 on the school bus. The parent is provided with a telephone number that the parent may call to find out information on the bus location. For example, a computer linked with the decoder 12 receives location information from the decoder 12 (from the transmission of the mobile unit 11 to the decoder 12) and relays that information to the parent caller, which, for example, may be in the form of audible speech.

According to alternate embodiments, a subscriber may access the location information on a web site through a computer or smart phone. Another embodiment provides location information at the location where a number of users are able to view the information. For example, the bus stop may have a map that shows the location of the bus for that route (and possibly other routes, e.g., connecting buses). The map may be provided on the panels of the bus stop stand or cover, and may include the location information from the mobile unit 11 that is carried on the bus. The decoder 12 receives the location information from the mobile unit 11, and the location information is processed and displayed on the map that is a screen at the bus stop or station. This may be done through a communication link between the decoder 12 and/or computer used therewith. For example, the bus stop may have a map that the transit authority uses to show names of stops for a particular bus route, e.g., an “orange line”, and the map may include an overlay of the location information that represents the bus with an icon and an indication of the time at which the bus is at a particular location.

According to an alternate embodiment, the system, method and device may be provided for controlling the movement of an object, such as, for example, a vehicle. For example, microcontrollers may be employed in connection with the mobile unit 11. The microcontroller may have ports (e.g., I/O ports) that can be associated with functions of a vehicle, such as, for example, turn on/off braking, turn off/on acceleration, and other functions that may be assigned to one or more of the ports of the microcontroller. For example, linear ports may be provided so that voltages may be read or regulated (e.g., increased or decreased) so that the responses from mechanical or electronic equipment may be obtained and relayed to a remote location through the decoder 12. For example, where cargo of a sensitive nature (e.g., radioactive material) is being delivered, it may be desirable to monitor a driver for signs of heart rhythm or other confirming information that shows that the driver is well. In the event that the confirming information is not received or in the event information to the contrary is returned to the decoder 12 (the driver having a heart attack), then the alerting mechanism may be employed to alert an individual. Alternately, the alerting mechanism may be linked with a control mechanism that is controlled with software that instructs the microprocessor to apply brakes or prevent further movement or alternate movement, of the vehicle.

These and other advantages may be obtained through the use of the inventive apparatus and methods disclosed herein. Although discussed in connection with wireless cellular telephone networks (e.g., radio frequency transmission), alternate voice channels, such as those of a satellite telephone network, may be employed with the invention disclosed herein. According to preferred embodiments, the present invention permits the users of the cellular telephone network to communicate location information between themselves, without additional services, as the existing cellular telephone services may be used to communicate the location information between the transmitting component (e.g. the mobile unit 11) and the decoding component, such as the decoder 12. The present invention also enables the provision of secure exchanges of location information between the mobile unit 11 and the decoder 12 which represents an improvement over SMS type communication systems and web based systems. In addition, although not shown, the mobile unit 11 and decoder 12 each may be provided with a housing to enclose some or all of their respective components. The invention is useful in a number of applications, including transit services, law enforcement, advertising, parades and events, and other situations where the tracking of an object's location is important or useful. The uses set forth and discussed herein are exemplary uses, and the mobile unit 11, decoder 12 and system may be used where it is desired to monitor and track an object's location or movement.

While the invention has been described with reference to specific embodiments, the description is illustrative and is not to be construed as limiting the scope of the invention. Various modifications and changes may occur to those skilled in the art without departing from the spirit and scope of the invention described herein and as defined by the appended claims.

What is claimed is:

1. A system for locating and monitoring the movement of an object, the system comprising:
a transmitting component;
a decoding component;
said decoding component being configured to communicate with said transmitting component;
wherein said transmitting component includes a global positioning system (GPS) chip, and wherein said GPS chip is linked with said transmitting component to transmit location information to said decoding component, and
wherein said transmitting component is configured to communicate through a voice channel.

2. The system of claim 1, including map software for generating a display of a map, and wherein said location information transmitted to said decoding component from said transmitting component is displayed on said display of a map.

3. The system of claim 2, wherein said location information is displayed on said map and wherein an icon is provided on said map to represent the location of said transmitting component.

4. The system of claim 1, including a management engine for managing access to the location information.

5. The system of claim 4, including a speech translation engine for translating location information to audible voice speech.

6. The system of claim 4, wherein said management engine regulates access to said location information to track the location of an object.

7. The system of claim 6, wherein said management engine manages subscriptions, and wherein subscriber access to the location information is regulated based on the subscription parameters of said subscriber.

8. A method of locating and monitoring the movement of an object, comprising:
providing a transmitting component;
providing a decoding component that is configured to communicate with said transmitting component;
wherein said transmitting component includes a global positioning system (GPS) chip, and wherein said GPS chip is linked with said transmitting component to transmit location information to said decoding component, and
communicating location information through a voice channel to said decoder component with said transmitting component, wherein said location information includes the location of said transmitting component.

9. The method of claim 8, wherein said communicating takes place over a duration of time while said transmitting component is moving.

10. The method of claim 9, further including a handset linked with said transmitting component, wherein said decoder component is linked with a computer with a computer communication network, and wherein the method includes placing voice telephone calls through said computer through said computer communication network wherein said voice telephone calls transacted with said computer communication network involve communicating the information for said voice telephone calls between said transmitting component and said decoder component, wherein said decoder component is arranged to transmit to said computer and receive from said computer voice telephone transmissions from said mobile unit and voice telephone receptions from said computer communication network.

11. An apparatus for locating and monitoring the movement of an object comprising:
a decoding component;
a transmitting component having wireless network communication circuitry for communicating on a voice channel of a wireless network and having a global positioning system (GPS) chip for transmitting location information of said transmitting component to said decoding component, said transmitting component being configured to communicate location information to said decoding component on said voice channel;
said decoding component being configured to communicate with said transmitting component to receive location information from said transmitting component;
software for managing the information received from said decoding component so that the information transmitted from said transmitting component may be displayed and stored.

12. The system of claim 7, wherein said subscription for receiving said location information is configured to have the subscriber dial a telephone number and receive audible information.

13. The system of claim 7, wherein said subscription for receiving said location information is configured to have the subscriber access a web site to view the location information.

14. The system of claim 1, wherein said communication through said voice channel comprises DTMF signals.

15. The system of claim 1, wherein said transmitting component is configured to communicate through a voice channel of a satellite telephone network.

16. The system of claim 1, wherein said transmitting component is configured to communicate through a voice channel of a cellular telephone network.

17. The system of claim 1, wherein said transmitting component is configured to conduct communications through a voice channel of a satellite telephone network and a voice channel of a cellular telephone.
